(19) United States
(12) Patent Application Publication
(10) Pub. No.: US 2026/0067730 A1
(43) Pub. Date: Mar. 5, 2026

(54) A MICROWAVE COMMUNICATION NODE FOR DETECTING AND MITIGATING INTERFERENCE

(71) Applicant: Telefonaktiebolaget LM Ericsson (publ), Stockholm (SE)

(72) Inventors: Magnus NILSSON, Kungsbacka (SE); Henrik SAHLIN, Mölnlycke (SE); Lei BAO, Göteborg (SE); Christoffer FOUGSTEDT, Göteborg (SE); Mikael COLDREY, Borås (SE); Oskar TALCOTH, Göteborg (SE); Christian CZEGLEDI, Göteborg (SE); Per-Arne THORSÉN, Öjersjö (SE); Rahul DEVASSY, Göteborg (SE)

(73) Assignee: Telefonaktiebolaget LM Ericsson (publ), Stockholm (SE)

(21) Appl. No.: 19/106,440

(22) PCT Filed: Aug. 30, 2022
(86) PCT No.: PCT/SE2022/050777

§ 371 Date: Feb. 25, 2025

(51) Int. Cl. H04W 24/10

(52) U.S. Cl. CPC H04W 24/10

(57) ABSTRACT

The disclosure relates to a microwave communication node and method for detecting and mitigating interference in a microwave network. The microwave communication node comprises a transmitter configured to broadcast a preamble that allows other microwave communication nodes to identify the microwave communication node as the sender, and a receiver configured to detect preambles broadcasted by other microwave communication nodes and determine interference levels of the other nodes by measuring signal strength and identifying the sender of each received preamble.

### TECHNICAL FIELD

The present invention relates to a microwave communication node and a method in a microwave communication node for detecting and mitigating interference.

### BACKGROUND

Data traffic in radio access networks is growing rapidly. The increase in traffic implies a densification of the radio access network using smaller cells. This densification will also impact the microwave backhaul network. At the same time, there is a trend of higher frequency reuse in microwave networks to save costs. Current microwave backhaul networks avoid interference by careful planning, but increased densification and higher frequency reuse will inevitably lead to more interference between radio links. Hence, future microwave networks will require new tools that allow for control and mitigation of interference.

Another problem is that existing power control methods combined with higher frequency reuse can lead to power rushes, which in turn will cause unnecessary interference in the network. By having better knowledge of interference levels in the microwave network, the transmit power of the links could be controlled in a smarter way.

There are currently no means of identifying how different microwave communication nodes in the microwave backhaul network interfere with one another. Hence, to allow further densification of radio access networks, there is a need for effective interference detection and mitigation between communication nodes in the microwave backhaul network.

### SUMMARY

It is an object of the present invention to remedy, or at least alleviate, some of these drawbacks and to provide a communication node that can detect and mitigate interference.

According to a first aspect, the invention describes a microwave communication node arranged for communication with at least one other microwave communication node in a microwave network. The microwave communication node comprising a transmitter configured to operate according to a set of transmit parameters, and a receiver configured to operate according to a set of receive parameters. The microwave communication node being characterized in that the transmitter is configured to broadcast a preamble that allows other microwave communication nodes to identify the microwave communication node as the sender, and the receiver is configured to detect preambles broadcasted by other microwave communication nodes and determine interference levels by measuring signal strength and identifying the sender of each received preamble. The receiver is further configured to report the determined interference levels to a network control unit.

According to a second aspect, the invention describes a method in a communication node for detecting and mitigating interference. The microwave communication node is comprising a transmitter and a receiver configured to operate according to a set of transmit-receive parameters. The microwave communication node is arranged for communication with at least one other microwave communication node in a microwave network. The method is comprising the step of broadcasting a preamble that allows other microwave communication nodes to identify the microwave communication node as the sender. The method is also comprising the step of detecting preambles broadcasted by other microwave communication nodes and determining interference levels by measuring signal strength and identifying the sender of each received preamble. The method is further comprising the step of reporting the determined interference levels to a network control unit.

In the above communication node and method, interference between microwave communication nodes can be detected and mitigated. Hence, the above communication node and method have the advantage of enabling increased frequency reuse and densification.

### BRIEF DESCRIPTION OF THE DRAWINGS

FIG. 1 shows schematically in a block diagram a microwave backhaul network according to a first embodiment of the invention,

FIG. 2 shows schematically in a block diagram a microwave backhaul network according to a second embodiment of the invention,

FIG. 3 shows schematically in a block diagram a microwave backhaul network according to a third embodiment of the invention,

FIG. 4A shows schematically in a block diagram a microwave communication node according to the first and second embodiment of the invention,

FIG. 4B shows schematically in a block diagram a microwave communication node according to the third embodiment of the invention,

FIG. 5A shows schematically in a flowchart a method according to a fourth, fifth and sixth embodiment of the invention,

FIG. 5B shows schematically in a flowchart a method according to a fourth, fifth and sixth embodiment of the invention,

FIG. 5C shows schematically in a flowchart a method according to a fourth, fifth and sixth embodiment of the invention,

FIG. 6 shows schematically an example of a hardware implementation of the present invention.

The drawings are not necessarily to scale, and the dimensions of certain features may have been exaggerated for the sake of clarity. Emphasis is instead being placed upon illustrating the principle of the embodiments herein.

### DETAILED DESCRIPTION

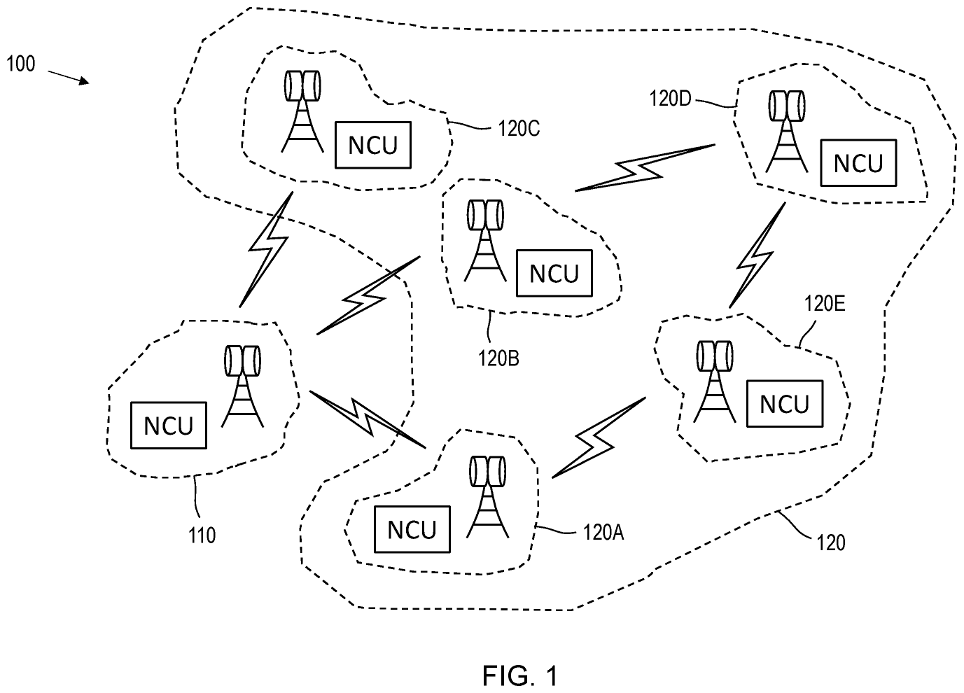

Six embodiments of the present invention and variants thereof are described in detail below with reference to FIGS. 1-6. A first, a second, and a third embodiment of the invention relates to a microwave communication node 110, 210, 310. A fourth, a fifth, and sixth embodiment relates to a method in a communication node 110, 210, 310. It should be noted that the scope of the present invention is not limited to the particular embodiments described herein, but only limited by the appended claims.

The following abbreviations are used in the text and the drawings:
NCU Network Control Unit
RX Receiver
TX Transmitter

The invention relates to a communication node 110, 210, 310 and a method for detecting and mitigating interference in a microwave network.

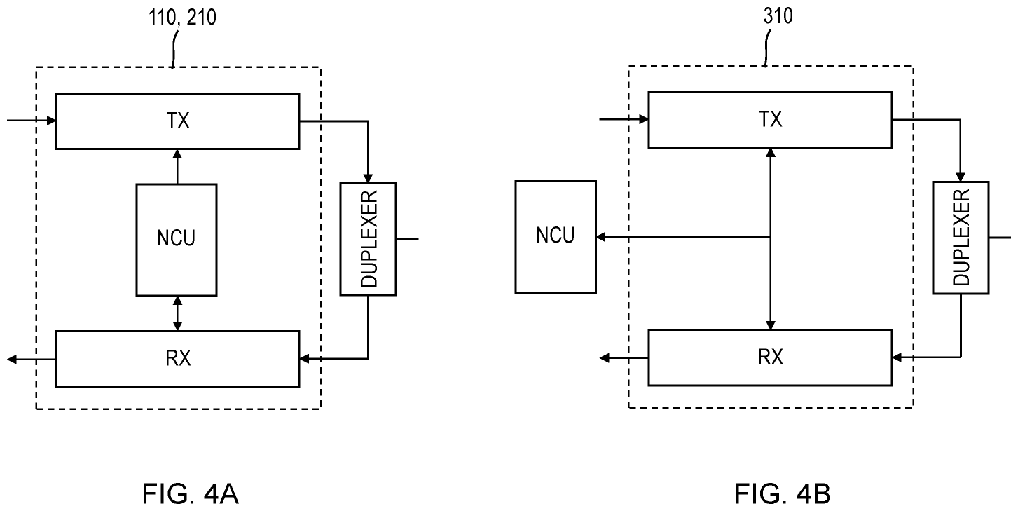

In the following, features of the first embodiment and variants thereof are described with reference to FIGS. 1 and 4A. The first embodiment relates to a microwave communication node 110 configured to detect and mitigate interference in a microwave network 100.

FIG. 1 depicts a microwave network 100 comprising a microwave communication node 110 in accordance with the first embodiment. The microwave communication node 110 is arranged for communication with at least one other microwave communication node 120A-C in the microwave network 100. The microwave communication node 110 comprises a network control unit. Other communication nodes 120 in the microwave network 100 will typically also comprise a network control unit.

FIG. 4A depicts a block diagram of the microwave communication node 110 comprising a transmitter, a receiver and a network control unit. An optional duplexer allows the transmitter and receiver to use the same antenna. The microwave communication node 110 may comprise additional transmitters and receivers if configured for communication with multiple other microwave communication nodes.

The transmitter is configured to operate according to a set of transmit parameters, e.g. transmit power, antenna orientation and beamwidth. The transmitter is further configured to broadcast a preamble that allows other microwave communication nodes 120 to identify the microwave communication node as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The preamble may be transmitted periodically or aperiodically, e.g. following a request by the network control unit.

The receiver is configured to operate according to a set of receive parameters, e.g. antenna orientation and beamwidth. The receiver is configured to detect preambles broadcasted by other microwave communication nodes 120 and determine interference levels by measuring signal strength and identifying the sender of each received preamble. In one example, the receiver computes the cross-correlation between a received symbol sequence and a list of known preambles, wherein the known preambles are associated with other microwave communication nodes 120 in the microwave network 100. The receiver is configured to report the determined interference levels to the network control unit. The receiver may further be configured to receive additional interference levels from other microwave communication nodes 120 in the microwave network 100, and report said additional interference levels to the network control unit.

In the first embodiment, a network control unit is comprised in the microwave communication node 110. The network control unit is configured to determine updated transmit-receive parameters for at least one microwave communication node in the microwave network 100 when an interference level exceeds a threshold value. Here, the threshold value represents an interference level that is deemed too high for reliable communication. The threshold value may depend on channel conditions, capacity demands, traffic requirements or any other conditions that affect the communication link.

In one example, all network control units in the microwave network 100 operate on the same data, i.e. same interference levels. In that case it is preferable that the network control unit only determines updated transmit-receive parameters to the local microwave communication node 110. In another example, the network control units in the microwave network 100 do not share the same data, e.g. if only interference levels detected locally are available at the network control unit. In that case it is preferable that the network control unit also determines updated transmit-receive parameters for other microwave communication nodes 120 in the microwave network.

The updated transmit-receive parameters may be any transmit parameter, receive parameter or other measure that will reduce the interference level. The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

If the updated transmit-receive parameters concern any of the other microwave communication nodes 120, the microwave communication node is configured to forward the updated transmit-receive parameters to the at least one microwave communication node. In one example, this is achieved by using the radio links of the microwave network to pass the updated transmit-receive parameters to a target microwave communication node. In another example, the updated transmit-receive parameters may be encoded in the preamble. For example, this can be achieved if the transmitter instead of one preamble has a codebook of preambles, where the entries in the codebook correspond to different measures for reducing the interference.

The receiver may be configured to receive updated transmit-receive parameters from other microwave communication nodes 120 in the microwave network 100. The transmitter and/or receiver may further be configured to adopt said updated transmit-receive parameters.

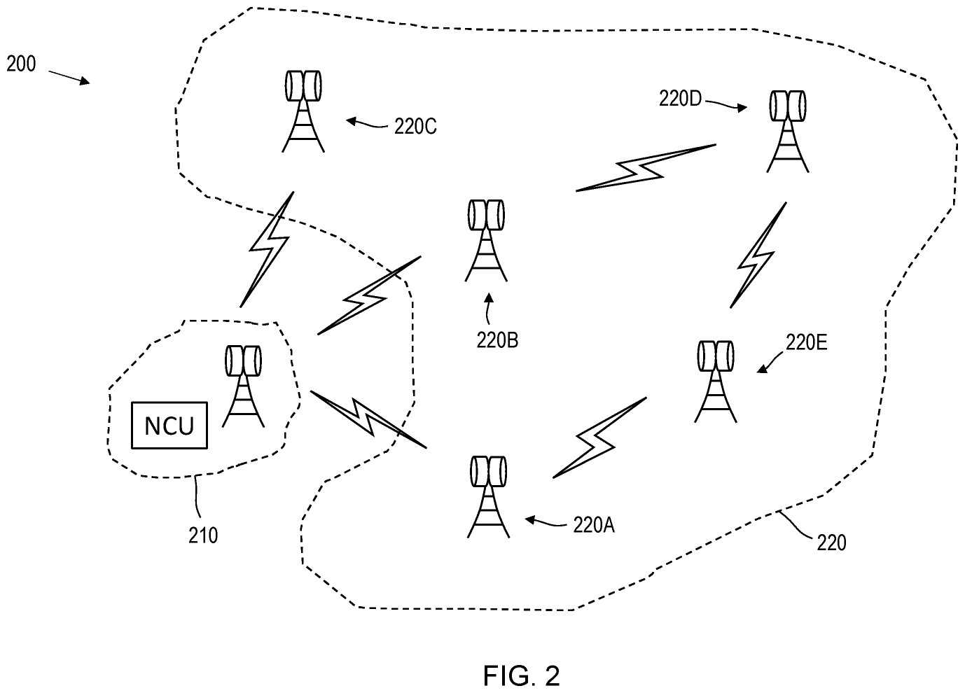

In the following, features of the second embodiment and variants thereof are described with reference to FIGS. 2 and 4A. The second embodiment relates to a microwave communication node 210 configured to detect and mitigate interference in a microwave network 200.

FIG. 2 depicts a microwave network 200 comprising a microwave communication node 210 in accordance with the second embodiment. The microwave communication node 210 is arranged for communication with at least one other microwave communication node 220A-C in the microwave network 200. The microwave communication node 210 comprises a network control unit. Other communication nodes 220 in the microwave network 200 do not comprise a network control unit. Or at least, most other communication nodes 220 in the microwave network 200 do not comprise a network control unit.

FIG. 4A depicts a block diagram of the microwave communication node 210 comprising a transmitter, a receiver and a network control unit. An optional duplexer allows the transmitter and receiver to use the same antenna. The microwave communication node 210 may comprise additional transmitters and receivers if configured for communication with multiple other microwave communication nodes.

The transmitter is configured to operate according to a set of transmit parameters, e.g. transmit power, antenna orientation and beamwidth. The transmitter is further configured to broadcast a preamble that allows other microwave communication nodes 220 to identify the microwave communication node as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The preamble may be transmitted periodically or aperiodically, e.g. following a request by the network control unit.

The receiver is configured to operate according to a set of receive parameters, e.g. antenna orientation and beamwidth. The receiver is configured to detect preambles broadcasted by other microwave communication nodes 220 and determine interference levels by measuring signal strength and identifying the sender of each received preamble. In one example, the receiver computes the cross-correlation between the received symbol sequence and a list of known preambles, wherein the known preambles are associated with other microwave communication nodes 120 in the microwave network 100. The receiver is configured to report the determined interference levels to the network control unit. The receiver may further be configured to receive additional interference levels from other microwave communication nodes 220 in the microwave network 200, and report said additional interference levels to the network control unit.

In the first embodiment, the network control unit is comprised in the microwave communication node 210. The network control unit is configured to determine updated transmit-receive parameters for at least one microwave communication node in the microwave network 200 when an interference level exceeds a threshold value. Here, the threshold value represents an interference level that is deemed too high for reliable communication. The threshold value may depend on channel conditions, capacity demands, traffic requirements or any other conditions that affect the communication link.

The updated transmit-receive parameters may be any transmit parameter, receive parameter or other measure that will reduce the interference level. The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

If the updated transmit-receive parameters concern any of the other microwave communication nodes 220, the microwave communication node is configured to forward the updated transmit-receive parameters to the at least one microwave communication node. In one example, this is achieved by using the radio links of the microwave network to pass the updated transmit-receive parameters to a target microwave communication node. In another example, the updated transmit-receive parameters may be encoded in the preamble. For example, this can be achieved if the transmitter instead of one preamble has a codebook of preambles, where the entries in the codebook correspond to different measures for reducing the interference.

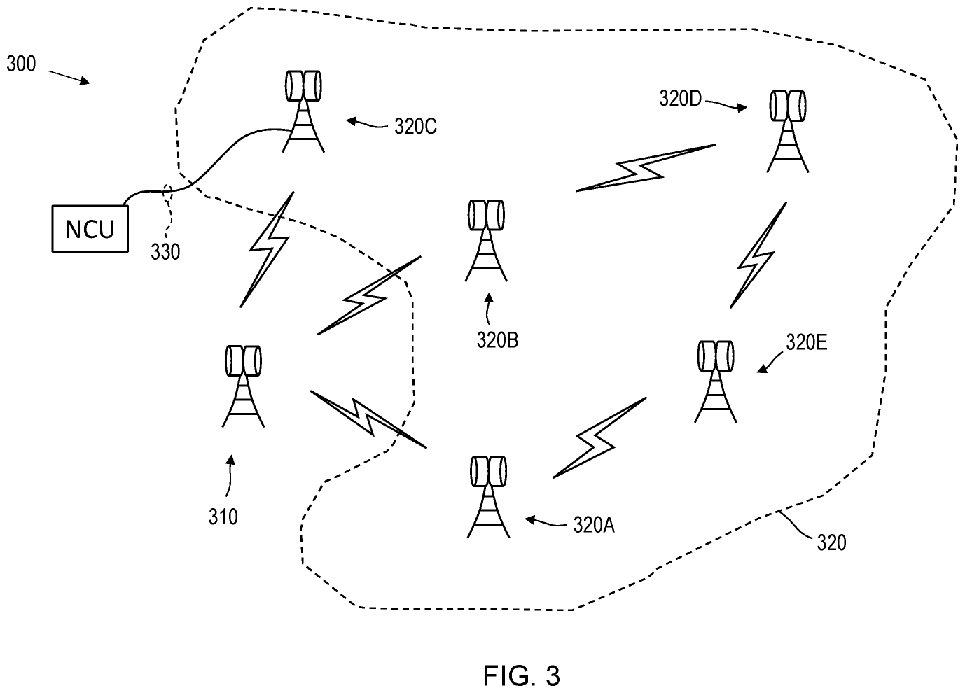

In the following, features of the third embodiment and variants thereof are described with reference to FIGS. 3 and 4B. The second embodiment relates to a microwave communication node 310 configured to detect and mitigate interference in a microwave network 300.

FIG. 3 depicts a microwave network 300 comprising a microwave communication node 310 in accordance with the third embodiment. The microwave communication node 310 is arranged for communication with at least one other microwave communication node 320A-C in the microwave network 300. The microwave communication node 310 according to the third embodiment does not comprise a network control unit. Other communication nodes 220 in the microwave network 200 may or may not comprise a network control unit, but at least one node has a connection 330, physically and/or wirelessly, to a network control unit.

FIG. 4B depicts a block diagram of the microwave communication node 310 comprising a transmitter and a receiver. An optional duplexer allows the transmitter and receiver to use the same antenna. The microwave communication node 310 is connected, physically and/or wirelessly, to a network control unit. Typically, the microwave communication node 310 is connected to the network control unit via other microwave communication nodes 320 in the microwave network 300. The microwave communication node 310 may comprise additional transmitters and receivers if configured for communication with multiple other microwave communication nodes.

The transmitter is configured to operate according to a set of transmit parameters, e.g. transmit power, antenna orientation and beamwidth. The transmitter is further configured to broadcast a preamble that allows other microwave communication nodes 320 to identify the microwave communication node as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The preamble may be transmitted periodically or aperiodically, e.g. following a request by the network control unit.

The receiver is configured to operate according to a set of receive parameters, e.g. antenna orientation and beamwidth. The receiver is configured to detect preambles broadcasted by other microwave communication nodes 320 and determine interference levels by measuring signal strength and identifying the sender of each received preamble. In one example, the receiver computes the cross-correlation between the received symbol sequence and a list of known preambles, wherein the known preambles are associated with other microwave communication nodes 120 in the microwave network 100. The receiver is configured to report the determined interference levels to the network control unit. The receiver may further be configured to receive additional interference levels from other microwave communication nodes 320 in the microwave network 300, and report said additional interference levels to the network control unit. In the third embodiment, the network control unit is not comprised in the microwave communication node 310.

The receiver may further be configured to receive updated transmit-receive parameters directly from the network control unit or via other microwave communication nodes 320 in the microwave network 300. If the updated transmit-receive parameters concern any of the other microwave communication nodes 220, the microwave communication node may be configured to forward the updated transmit-receive parameters to the target microwave communication node. The transmitter and/or receiver may further be configured to adopt said updated transmit-receive parameters.

In the following, features of the fourth embodiment and variants thereof are described with reference to FIGS. 1, 4A and 5A-C. The fourth embodiment relates to a method in a microwave communication node 110 for detecting and mitigating interference.

FIG. 1 depicts a microwave network 100 comprising a microwave communication node 110 configured to perform the method according to the fourth embodiment. The microwave communication node 110 is arranged for communication with at least one other microwave communication node 120A-C in the microwave network 100. The microwave communication node 110 comprises a network control unit. Other communication nodes 120 in the microwave network 100 will typically also comprise a network control unit.

FIG. 4A depicts a block diagram of the microwave communication node 110 comprising a transmitter, a receiver and a network control unit. An optional duplexer allows the transmitter and receiver to use the same antenna. The microwave communication node 110 may comprise additional transmitters and receivers if configured for communication with multiple other microwave communication nodes. The transmitter is configured to operate according to a set of transmit parameters, e.g. transmit power, antenna orientation and beamwidth. Likewise, the receiver is configured to operate according to a set of receive parameters, e.g. antenna orientation and beamwidth.

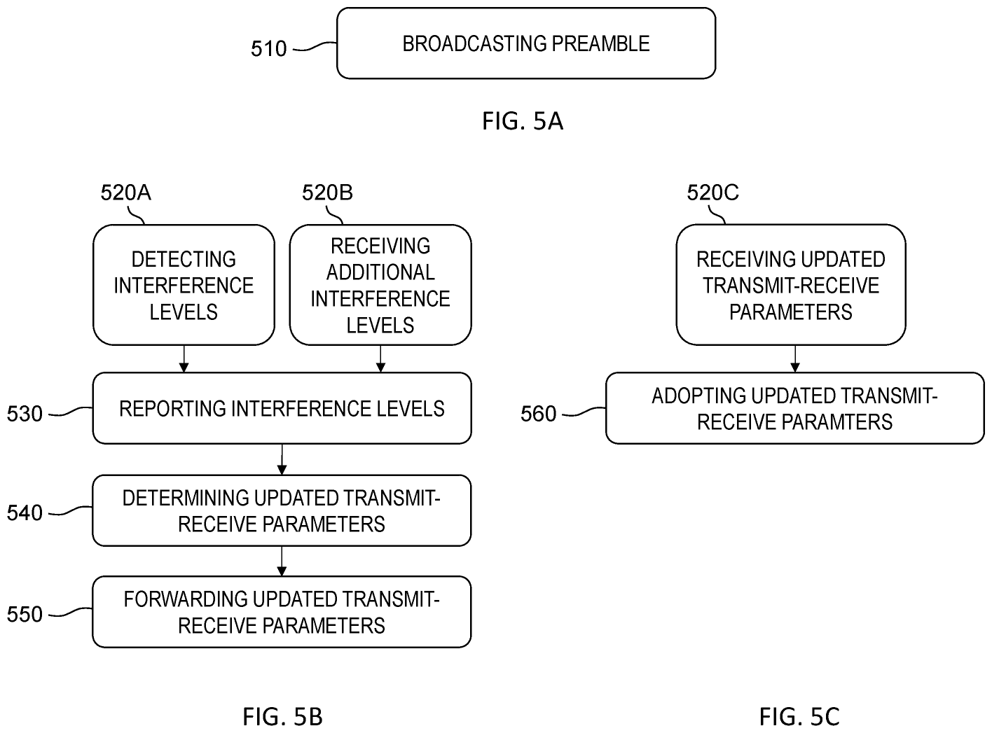

FIG. 5A-C depict the steps performed according to the fourth embodiment of the invention.

FIG. 5A depicts the step of broadcasting. The transmitter is configured to perform the step of broadcasting 510 in the microwave communication node. Broadcasting 510 comprises transmitting a preamble that allows other microwave communication nodes 120 in the microwave network 100 to identify the microwave communication node 110 as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The step of broadcasting may be performed periodically or aperiodically, e.g. following a request by the network control unit.

FIG. 5B depicts the step of detecting 520A. The receiver is configured to perform the step of detecting 520A preambles broadcasted by other microwave communication nodes 120 and determining the interference levels by measuring signal strength and identifying the sender of each received preamble. In one example, detecting 520A comprises computing the cross-correlation between the received symbol sequence and a list of known preambles, wherein the known preambles are associated with other microwave communication nodes 120 in the microwave network 100. The receiver is further configured to perform the step of reporting the determined interference levels to the network control unit. The receiver may further be configured to perform the step of receiving 520B additional interference levels from other microwave communication nodes 120 in the microwave network 100. The step of reporting 530 may further comprise reporting said additional interference levels to the network control unit.

FIG. 5B further depicts the step of determining 540. According to the fourth embodiment, the network control unit is comprised in the microwave communication node 110. The network control unit is configured to perform the step of determining 540 updated transmit-receive parameters for at least one microwave communication node in the microwave network 100 when an interference level exceeds a threshold value. Here, the threshold value represents an interference level that is deemed too high for reliable communication. The threshold value may depend on channel conditions, capacity demands, traffic requirements or any other conditions that affect the communication link.

In one example, all network control units in the microwave network 100 operate on the same data, i.e. same interference levels. In that case it is preferable that the step of determining 540 only involves determining updated transmit-receive parameters for the local microwave communication node 110. In another example, the network control units in the microwave network 100 do not share the same data, e.g. if only interference levels detected locally are available at the network control unit. In that case it is preferable that the step of determining 540 involve determining updated transmit-receive parameters for other microwave communication nodes 120 in the microwave network.

The updated transmit-receive parameters may be any transmit parameter, receive parameter or other measure that will reduce the interference level. The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

FIG. 5B further depicts the step of forwarding 550. If the updated transmit-receive parameters concern any of the other microwave communication nodes 120, the microwave communication node may be configured to perform the step of forwarding 550 the updated transmit-receive parameters to the at least one microwave communication node. In one example, this is achieved by using the radio links of the microwave network to pass the updated transmit-receive parameters to a target microwave communication node. In another example, the updated transmit-receive parameters may be encoded in the preamble. For example, this can be achieved if the transmitter instead of one preamble has a codebook of preambles, where the entries in the codebook correspond to different measures for reducing the interference.

FIG. 5C depicts the step of receiving 520C. The step of receiving may further comprise receiving 520C updated transmit-receive parameters from other microwave communication nodes 120 in the microwave network 100. The transmitter and/or receiver may further perform the step of adopting 560 said updated transmit-receive parameters.

In the following, features of the fifth embodiment and variants thereof are described with reference to FIGS. 2, 4A and 5A-B. The fifth embodiment relates to a method in a microwave communication node 110 for detecting and mitigating interference.

FIG. 2 depicts a microwave network 200 comprising a microwave communication node 210 configured to perform the method according to the fifth embodiment. The microwave communication node 210 is arranged for communication with at least one other microwave communication node 220A-C in the microwave network 200.

FIG. 4A depicts a block diagram of the microwave communication node 210 comprising a transmitter, a receiver and a network control unit. An optional duplexer allows the transmitter and receiver to use the same antenna. The microwave communication node 210 may comprise additional transmitters and receivers if configured for communication with multiple other microwave communication nodes. The transmitter is configured to operate according to a set of transmit parameters, e.g. transmit power, antenna orientation and beamwidth. Likewise, the receiver is configured to operate according to a set of receive parameters, e.g. antenna orientation and beamwidth.

FIG. 5A-B depict the steps performed according to the fifth embodiment of the invention.

FIG. 5A depicts the step of broadcasting. The transmitter is configured to perform the step of broadcasting 510 in the microwave communication node. Broadcasting 510 comprises transmitting a preamble that allows other microwave communication nodes 220 in the microwave network 200 to identify the microwave communication node 210 as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The step of broadcasting may be performed periodically or aperiodically, e.g. following a request by the network control unit.

FIG. 5B depicts the step of detecting 520A. The receiver is configured to perform the step of detecting 520A preambles broadcasted by other microwave communication nodes 220 and determining the interference levels by measuring signal strength and identifying the sender of each received preamble. In one example, detecting 520A comprises computing the cross-correlation between the received symbol sequence and a list of known preambles, wherein the known preambles are associated with other microwave communication nodes 120 in the microwave network 100. The receiver is further configured to perform the step of reporting the determined interference levels to the network control unit. The receiver may further be configured to perform the step of receiving 520B additional interference levels from other microwave communication nodes 220 in the microwave network 100. The step of reporting 530 may further comprise reporting said additional interference levels to the network control unit.

FIG. 5B further depicts the step of determining 540. According to the fifth embodiment, the network control unit is comprised in the microwave communication node 110. The network control unit is configured to perform the step of determining 540 updated transmit-receive parameters for at least one microwave communication node in the microwave network 200 when an interference level exceeds a threshold value. Here, the threshold value represents an interference level that is deemed too high for reliable communication. The threshold value may depend on channel conditions, capacity demands, traffic requirements or any other conditions that affect the communication link.

The updated transmit-receive parameters may be any transmit parameter, receive parameter or other measure that will reduce the interference level. The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

FIG. 5B further depicts the step of forwarding 550. If the updated transmit-receive parameters concern any of the other microwave communication nodes 220, the microwave communication node may be configured to perform the step of forwarding 550 the updated transmit-receive parameters to the at least one microwave communication node. In one example, this is achieved by using the radio links of the microwave network to pass the updated transmit-receive parameters to a target microwave communication node. In another example, the updated transmit-receive parameters may be encoded in the preamble. For example, this can be achieved if the transmitter instead of one preamble has a codebook of preambles, where the entries in the codebook correspond to different measures for reducing the interference.

In the following, features of the sixth embodiment and variants thereof are described with reference to FIGS. 3, 4A and 5A-C. The sixth embodiment relates to a method in a microwave communication node 110 for detecting and mitigating interference.

FIG. 3 depicts a microwave network 300 comprising a microwave communication node 310 configured to perform the method according to the fourth embodiment. The microwave communication node 310 is arranged for communication with at least one other microwave communication node 320A-C in the microwave network 300.

FIG. 4B depicts a block diagram of the microwave communication node 310 comprising a transmitter and a receiver. An optional duplexer allows the transmitter and receiver to use the same antenna. The microwave communication node 110 may comprise additional transmitters and receivers if configured for communication with multiple other microwave communication nodes. The transmitter is configured to operate according to a set of transmit parameters, e.g. transmit power, antenna orientation and beamwidth. Likewise, the receiver is configured to operate according to a set of receive parameters, e.g. antenna orientation and beamwidth.

FIG. 5A-C depict the steps performed according to the sixth embodiment of the invention.

FIG. 5A depicts the step of broadcasting. The transmitter is configured to perform the step of broadcasting 510 in the microwave communication node. Broadcasting 510 comprises transmitting a preamble that allows other microwave communication nodes 320 in the microwave network 300 to identify the microwave communication node 310 as the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The step of broadcasting may be performed periodically or aperiodically, e.g. following a request by the network control unit.

FIG. 5B depicts the step of detecting 520A. The receiver is configured to perform the step of detecting 520A preambles broadcasted by other microwave communication nodes 320 and determining the interference levels by measuring signal strength and identifying the sender of each received preamble. In one example, detecting 520A comprises computing the cross-correlation between the received symbol sequence and a list of known preambles, wherein the known preambles are associated with other microwave communication nodes 120 in the microwave network 100. The receiver is further configured to perform the step of reporting the determined interference levels to the network control unit. The receiver may further be configured to perform the step of receiving 520B additional interference levels from other microwave communication nodes 320 in the microwave network 100.

The step of reporting 530 may further comprise reporting said additional interference levels to the network control unit. In the sixth embodiment, the network control unit is not comprised in the microwave communication node 310.

FIG. 5C depicts the step of receiving 520C updated transmit-receive parameters. The step of receiving may comprise receiving 520C updated transmit-receive parameters directly from the network control unit or via other microwave communication nodes 320 in the microwave network 300. If the updated transmit-receive parameters concern any of the other microwave communication nodes 220, the microwave communication node may be configured to perform the step of forwarding 550 the updated transmit-receive parameters to the target microwave communication node. The transmitter and/or receiver may further perform the step of adopting 560 said updated transmit-receive parameters.

In the following, some alternative aspects and variations on the above discussed embodiments are provided.

In one example, different preambles are assigned to different links. Each link knows the preambles of its neighbouring links.

In one example, the preamble is configured by a central unit, e.g. as operations, administration and management. The central unit is responsible for distributing a preamble list to the nodes in the network.

In one example, the encoded information in the preamble comprises at least one of link location, carrier frequency and transmission direction.

In one example, silent periods can be used as a special case of preamble with zero transmit power. This requires synchronization of the nodes.

In one example, the preamble is selected based on if a node experiences high interference level or not. Two sets of preambles are then predefined, one to be used for nodes which experience low interference and one set of preambles to be used by nodes which experience high interference levels. If a node detects a preamble belonging to the set of high interference nodes, then it can take actions to reduce interference for other nodes.

In one example, the two directional links in one microwave hop are assigned with different preambles. In a related embodiment, the two directional links in one microwave hop can share the same preamble.

In one example, the preamble list is updated and redistributed when new links are deployed in the system.

In one example, the preamble list is updated and redistributed when links are removed from the system.

In one example, identical preambles can be used by several microwave hops in the same backhaul network provided that the hops are sufficiently separated.

In one example, the detection algorithm detects the preambles of neighbouring links and calculates its amount of interference.

In one example, all the links are synchronized such that they can transmit their preambles at the same time.

In one example, the transmission and measurement of the preambles are coordinated. The coordination may avoid situations when two links which should perform mutual measurements go silent at the same time.

In one example, the interference level can be determined based on, but not limited to, RSSI (Received Signal Strength Indicator), SINR (Signal-to-Interference-Noise Ratio), MSE (Mean Squared Error), RSRP (Reference Signal Received Power), RSRQ (Reference Signal Received Quality). The reference signal is referred to the preamble.

In one example, interference level can be calculated by using the preamble to first calculate the interference channel. The interference level is then given by the interference channel and transmitted power of the interfering link.

In one example, the measurement report is sent to the central unit.

In one example, the measurement report is sent to the interfering node directly or via central unit. Direct transmissions between nodes can be either over air or wired.

In one example, the node does not report its measurements but instead make node internal actions to reduce interference such as changing transmission power and beam steering.

In one example, the interference mitigation is controlled by the central unit, e.g. the central unit makes the decision and informs the interfering and victim units.

In one example, the interference mitigation is performed without centralized control, e.g., the interfering unit informs the victim unit about interference situation.

In one example, the victim unit cannot mandate the interfering unit to change the transmission configuration.

In one example, the interfering unit may signal ACK/NACK message to the victim unit about the change of the transmission configuration.

In one example, transmission configuration can be configuring transmit powers of the links.

In one example, transmission configuration can be configuring frequency channels for bi-directional traffic over the links (“UL/DL”).

In one example, transmission configuration can be configuring both transmit power and frequency channels.

In one example, the input to the central node can be system and deployment parameters of one microwave hop such as antenna type, link position and network topology.

In one example, the input to the central node can be capacity and traffic requirement related parameters such as QoS, capacity demand and available bandwidth.

In one example, the input to the central node can be operational conditions such as pathloss, propagation channel conditions, interference levels and buffer status.

In one example, the decision from the central node can be power related adjustment, such as transmit power.

In one example, the decision from the central node can be data rate adjustment, such as modulation and coding.

In one example, the decision from the central node can be carrier related adjustment, such as carrier allocation and carrier bandwidth.

In one example, the decision from the central node can be antenna adjustment, such as antenna tilt, beam direction and beamforming.

In one example, the decision from the central node can be prioritization of the traffic data.

In one example, the decision from the central node can be a coordination of the reference signalling, including configuration of the reference signal at the aggressor node, e.g. reference signal preambles, and configuration of interference measurement at the victim node, e.g. the set of preambles to measure.

In one example, the communication between the central node and the microwave link can be wired or wireless connection.

In one example, the communication between the central node and a microwave link can be via one or several intermediate nodes.

In one example, two, or more, central nodes exchange information.

In one example, the central nodes can prioritize certain backhaul traffic between nodes, e.g. mission critical communications or first responders such as firefighters and ambulance. Other examples are to prioritize voice and online video over low priority data traffic.

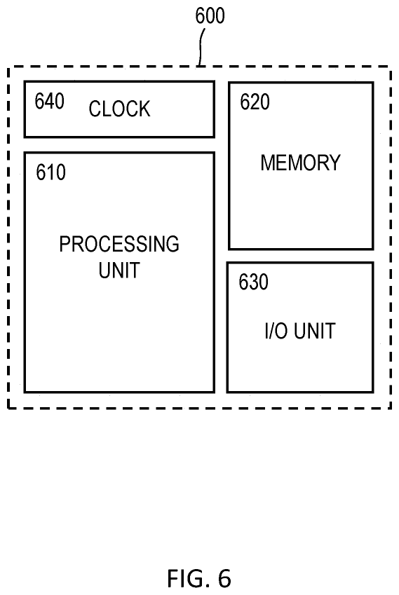

According to yet another aspect of the invention, the microwave communication node may be implemented as a processing unit 610, a memory 620, an input/output unit 630 and a clock 640 as is illustrated in FIG. 6. The processing unit 610, the memory 620, the I/O unit 630 and the clock 640 may be interconnected. The processing unit 610 may comprise a central processing unit, a digital signal processor, a multiprocessor system, programmable logic, a field programmable gate array (FPGA) or an application specific integrated circuit (ASIC) or any other type of logic. The memory 620 may comprise random access memory (RAM), read only memory (ROM) or any other type of volatile or non-volatile memory. The I/O unit 630 may comprise circuitry for controlling and performing signal conversions on I/O data and may further be connected to an antenna.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

1. A microwave communication node arranged for communication with at least one other microwave communication node in a microwave network, the microwave communication node comprising:
a transmitter configured to operate according to a set of transmit parameters, and
a receiver configured to operate according to a set of receive parameters,
wherein the transmitter is configured to broadcast a preamble that allows other microwave communication nodes to identify the microwave communication node as the sender,
the receiver is configured to detect preambles broadcasted by other microwave communication nodes and determine interference levels by measuring signal strength and identifying the sender of each received preamble, and
the receiver is configured to report the determined interference levels to a network control unit (NCU).

2. The microwave communication node according to claim 1, wherein
the receiver is further configured to receive additional interference levels from other microwave communication nodes in the microwave network, and
the receiver is further configured to report said additional interference levels to the network control unit (NCU).

3. The microwave communication node according to claim 1, wherein the network control unit (NCU) is comprised in the microwave communication node.

4. The microwave communication node according to claim 3, wherein
the network control unit (NCU) is configured to determine updated transmit-receive parameters for at least one microwave communication node in the microwave network when an interference level exceeds a threshold value, wherein the updated transmit-receive parameters correspond to a measure that will reduce the interference level that exceeds the threshold value, and
the microwave communication node is configured to forward the updated transmit-receive parameters to the at least one microwave communication node.

5. The microwave communication node according to claim 4, wherein the updated transmit-receive parameters are encoded in the preamble.

6. The microwave communication node according to claim 4, wherein the updated transmit-receive parameters comprise reducing transmit power.

7. The microwave communication node of claim 1, wherein
the receiver is further configured to receive updated transmit-receive parameters from other microwave communication nodes in the microwave network, and
the transmitter and/or receiver is further configured to adopt said updated transmit-receive parameters.

8. A method in a microwave communication node for detecting and mitigating interference, the microwave communication node comprising a transmitter and a receiver configured to operate according to a set of transmit-receive parameters, and wherein the microwave communication node is arranged for communication with at least one other microwave communication node in a microwave network, the method comprising:
broadcasting a preamble that allows other microwave communication nodes to identify the microwave communication node as the sender,
detecting preambles broadcasted by other microwave communication nodes and determining interference levels by measuring signal strength and identifying the sender of each received preamble, and
reporting the determined interference levels to a network control unit (NCU).

9. The method according to claim 8, wherein the method further comprises:
receiving additional interference levels from other microwave communication nodes in the microwave network, and
the step of reporting further comprises reporting said additional interference levels to the network control unit (NCU).

10. The method according to claim 8, wherein the microwave communication node comprises the network control unit (NCU), and the method further comprising:
determining updated transmit-receive parameters for at least one microwave communication node in the microwave network when an interference level exceeds a threshold value, wherein the updated transmit-receive parameters correspond to a measure that will reduce the interference level that exceeds the threshold value, and
forwarding the updated transmit-receive parameters to the at least one microwave communication node.

11. The method according to claim 10, wherein the forwarding comprises encoding the updated transmit-receive parameters in the preamble.

12. The method according to claim 10, wherein the updated transmit-receive parameters comprise reducing transmit power.

13. The method according to claim 8, further comprising:
receiving updated transmit-receive parameters from other microwave communication nodes in the microwave network, and
adopting said updated transmit-receive parameters.
